(19) United States
(12) Patent Application Publication
(10) Pub. No.: US 2016/0085497 A1
(43) Pub. Date: Mar. 24, 2016

(54) DISPLAY APPARATUS CONSTITUTING DISPLAY SYSTEM INCLUDING PLURALITY OF DISPLAY APPARATUSES, CONTENT DISPLAY METHOD THEREOF, AND DISPLAY SYSTEM INCLUDING PLURALITY OF DISPLAY APPARATUSES

(71) Applicant: SAMSUNG ELECTRONICS CO., LTD., Suwon-si (KR)

(72) Inventor: Jung-hyuk KIM, Suwon-si (KR)

(73) Assignee: SAMSUNG ELECTRONICS CO., LTD., Suwon-si (KR)

(21) Appl. No.: 14/848,561

(22) Filed: Sep. 9, 2015

(30) Foreign Application Priority Data
Sep. 23, 2014 (KR) 10-2014-0126681

(51) Int. Cl. G06F 3/14

(52) U.S. Cl. CPC G06F 3/1423

(57) ABSTRACT

A content display method for a display system including a plurality of display apparatuses is provided. The content display method includes transmitting first content pre-stored in a first display apparatus of the plurality of display apparatuses to a second display apparatus of the plurality of display apparatuses in order to display the first content on the second display apparatus, receiving second content stored in the another display apparatus, the second content being different from the first content, and displaying the pre-stored first content or the received second content based on an arrangement position of the plurality of display apparatuses.

### CROSS-REFERENCE TO RELATED APPLICATIONS

This application claims priority from Korean Patent Application No. 10-2014-0126681, filed on Sep. 23, 2014, in the Korean Intellectual Property Office, the disclosure of which is incorporated herein by reference in its entirety.

### BACKGROUND

1. Field

Apparatuses and methods consistent with the present exemplary embodiments relate to a display apparatus constituting a display system including a plurality of display apparatuses, a content display method thereof, and a display system including a plurality of display apparatuses, and more particularly, to a display apparatus constituting a display system including a plurality of display apparatuses with an extended content storing space, a content display method thereof, and a display system including a plurality of display apparatuses

2. Description of the Related Art

A display system including a plurality of display apparatuses is technology in which a plurality of display apparatuses are used together for advertisement, entertainment, sports, broadcasting, and so on so as to display one image.

For example, a display system including a plurality of display apparatuses is configured in such a way that the display apparatuses constituting the display system simultaneously display the same image or display different images as one whole image formed by combining the images.

In this case, one of a plurality of display apparatuses constituting a display system functions as a content source for providing content.

However, as content size is increased, storage space of one display apparatus functioning as a content source is insufficient to store content. Accordingly, an external storage device is connected to a display apparatus functioning as a content source so as to expand a storage space, but a separate external device needs to be purchased to increase costs.

### SUMMARY

Exemplary embodiments of the present disclosure overcome the above disadvantages and other disadvantages not described above. Also, the exemplary embodiments are not required to overcome the disadvantages described above, and an exemplary embodiment may not overcome any of the problems described above.

The present exemplary embodiments provide a display system including a plurality of display apparatuses that use storage spaces of a plurality of display apparatuses constituting a display system, a display apparatus constituting the display system, and a content display method thereof.

According to an aspect of the exemplary embodiments, a content display method for a display system including a plurality of display apparatuses includes transmitting first content pre-stored in the first display apparatus of the plurality of display apparatuses to a second display apparatus of the plurality of display apparatuses in order to display the first content on the second display apparatus, receiving second content stored in the second display apparatus, wherein the second content is different from the first content, and displaying on the display system, the pre-stored first content or the received second content based on an arrangement position of the plurality of display apparatuses.

The displaying may include displaying the pre-stored first content or the received second content based on pre-stored order information about a reproduction order of contents stored in the plurality of display apparatuses.

The transmitting may include transmitting the first content to the second display apparatus at a time for reproduction of the pre-stored first content wherein the time for reproduction is based on the order information.

The content display method may further include, in response to reproduction of the first content being terminated, transmitting a reproduction command for second content stored in the second display apparatus to the second display apparatus.

The second display apparatus to which the reproduction command is transmitted may be another display apparatus of the plurality of display apparatuses that stores second content corresponding to the order information.

The content display method may further include, in response to reproduction of the second content being terminated, receiving a reproduction command of the first content from the second display apparatus, wherein the transmitting may include transmitting the first content to the second display apparatus according to the received reproduction command of the first content.

The content display method may further include displaying a list of contents stored in the plurality of display apparatuses constituting the display system on the display unit, receiving the reproduction order of each display content, generating order information based on the input reproduction order of the displayed contents, and transmitting the generated order information to the second display apparatus.

The displaying of the list may include receiving information about content stored in another display apparatus from another display apparatus and displaying information about the received content as the list.

According to another aspect of the exemplary embodiments, a first display apparatus in a display system including a plurality of display apparatuses includes a communication interface configured to communicate with a second display apparatus of the plurality of display apparatuses, a storage configured to store content, a display configured to display content, and a controller configured to transmit first content pre-stored in the storage to the second display apparatus through the communication interface in order to display the first content on the second display apparatus, to receive second content stored in the second display apparatus, the second content being different form the first content, through the communication interface, and to display the pre-stored first content or the received second content on the display based on an arrangement position of the first display apparatus in relation to the plurality of display apparatuses.

The controller may display the pre-stored first content or the received second content based on pre-stored order information about a reproduction order of contents stored in the plurality of display apparatuses constituting the display system.

The controller may transmit the first content to another display apparatus of the plurality of display apparatuses at a time for reproduction of the pre-stored first content, wherein the time for reproduction is based on the order information.

The controller, in response to reproduction of the first content being terminated, may transmit a reproduction command of second content stored in the second display apparatus to another display apparatus of the plurality of display apparatuses.

Another display apparatus to which the reproduction command is transmitted may be another display apparatus that stores second content corresponding to the order information.

The controller may receive the second content from another display apparatus of the plurality of display apparatuses to which the reproduction command is transmitted.

The controller, in response to reproduction of the second content being terminated, may receive a reproduction command of the first content from the second display apparatus, and transmit the first content to the second display apparatus according to the received reproduction command of the first content.

The controller may display a list of contents stored in the plurality of display apparatuses on the display unit, generate order information based on an input reproduction order of the displayed contents received from a user, and transmit the generated order information to the second display apparatus.

A control command corresponding to the reproduction order may be received from a remote control apparatus that performs communication using a wireless communication, and the controller may disregard a control command received from the remote control apparatus when the first display apparatus is a slave apparatus controlled by another display apparatus.

The controller may receive information about content stored in the second display apparatus from the second display apparatus and display the received information as the list of the content on the display unit.

The controller may transmit a reproduction command regarding a content to be reproduced first to another display apparatus that stores the content to be reproduced first, based on the generated order information.

The controller may control a displayed form of an image display on the display unit according to a control command received from a remote control apparatus when the first display apparatus is a host apparatus, and disregard the control command received from the remote control apparatus when the display apparatus is a slave apparatus.

The controller may perform image-processing in order to display a portion of the first content or the second content on the display unit based on an arrangement position of the first display apparatus in relation to the plurality of display apparatuses.

The controller may also transmit information about an arrangement position of the second display apparatus in relation to the plurality of display apparatuses while transmitting the first content to the second display apparatus.

According to another aspect of the exemplary embodiments, a display system including a plurality of display apparatuses includes a first display apparatus configured to store first content and to display the first content on the plurality of display apparatuses, and a second display apparatus configured to store second content different from the first content, and to display the second content on the plurality of display apparatuses in response to reproduction of the first content being terminated.

The first display apparatus transmits a reproduction command to the second display apparatus in response to reproduction of the first content being terminated, and the second display apparatus may transmit the second content to the plurality of display apparatuses including the first display apparatus so as to display the second content by the plurality of display apparatuses in response to the reproduction command being received.

According to another aspect of the exemplary embodiments, a computer readable recording medium having recorded thereon a program for executing a content display method of a display system including a plurality of display apparatuses, the content display method including transmitting first content pre-stored in the first display apparatus of the plurality of display apparatuses to a second display apparatus of the plurality of display apparatuses in order to display the first content on the second display apparatus, receiving second content stored in the second display apparatus, different from the first content, and displaying the pre-stored first content or the received second content based on an arrangement position of the display apparatus on the display system.

According to yet another aspect of the exemplary embodiments, a method for displaying content, includes storing a first content on a first display apparatus of a plurality of display apparatuses, transmitting the first content to a second display apparatus of the plurality of display apparatuses; receiving second content from the second display apparatus, wherein the second content is different from the first content; and displaying the first content or the second content based on an arrangement position of the plurality of display apparatuses.

The method can further include transmitting the first content to a third display apparatus of the plurality of display apparatuses in order to relay it to the second apparatus.

The method can further include receiving the second content from a third display apparatus of the plurality of display apparatuses after the second display apparatus transmits the second content to the third apparatus.

The method can further include performing image processing on the first content to generate a split image from the first content based on the arrangement position of the plurality of display apparatuses, and displaying the split image.

The method can further include performing image processing on the second content to generate a split image from the second content based on the arrangement position of the plurality of display apparatuses, and displaying the split image.

The arrangement position of the plurality of display apparatuses includes a position of the first display apparatus in relation to a position of the second display apparatus.

According to the aforementioned various exemplary embodiments, a display system including a plurality of display apparatuses may use a storing space of a display apparatus, which was not conventionally used.

Additional and/or other aspects and advantages of the exemplary embodiments will be set forth in part in the description which follows and, in part, will be obvious from the description, or may be learned by practice of the exemplary embodiments.

### BRIEF DESCRIPTION OF THE DRAWING FIGURES

The above and/or other aspects of the exemplary embodiments will be more apparent by describing certain exemplary embodiments with reference to the accompanying drawings, in which:

FIGS. 1 and 2 are diagrams of a display system including a plurality of display apparatuses according to an exemplary embodiment;

FIG. 3 is a block diagram of a configuration of a display apparatus constituting a display system according to an exemplary embodiment;

FIG. 4 is a diagram illustrating a screen image used to receive user manipulation of generating a content reproduction order according to an exemplary embodiment;

FIG. 5 is a diagram of a content display state of a display system according to an exemplary embodiment;

FIG. 6 is a diagram of interaction between a remote control apparatus and a plurality of display apparatuses constituting a display system according to an exemplary embodiment; and

FIGS. 7 and 8 are diagrams of a content reproducing method of a display apparatus constituting a display system according to various exemplary embodiments.

### DETAILED DESCRIPTION OF THE EXEMPLARY EMBODIMENTS

Exemplary embodiments will be illustrated in the drawings and described in detail in the written description, with allowance for various changes. However, this is not intended to limit the present invention to particular modes of practice, and it is to be appreciated that all changes, equivalents, and substitutes that do not depart from the spirit and technical scope of the present invention are encompassed in this disclosure. In the description of the exemplary embodiments, certain detailed explanations of related art are omitted when it is deemed that they may unnecessarily obscure the essence of the exemplary embodiments.

The terms such as “first” and “second” are used herein merely to describe a variety of constituent elements, but the constituent elements are not limited by the terms. The terms are used only for the purpose of distinguishing one constituent element from another constituent element.

The terms used in the present specification are used for explaining a specific exemplary embodiment, not limiting the present inventive concept. Thus, the singular expressions in the present specification include the plural expressions unless clearly specified otherwise in context. Also, the terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

The terms, such as ‘unit’ or ‘module’, etc., should be understood as a unit that processes at least one function or operation and that may be embodied in a hardware manner, a software manner, or a combination of the hardware manner and the software manner. In addition, a plurality of ‘modules’ or a plurality of ‘units’ may be integrated as at least one module to be embodied as at least one processor (not shown) except for a ‘module’ or a ‘unit’ which needs to be embodied in specific hardware.

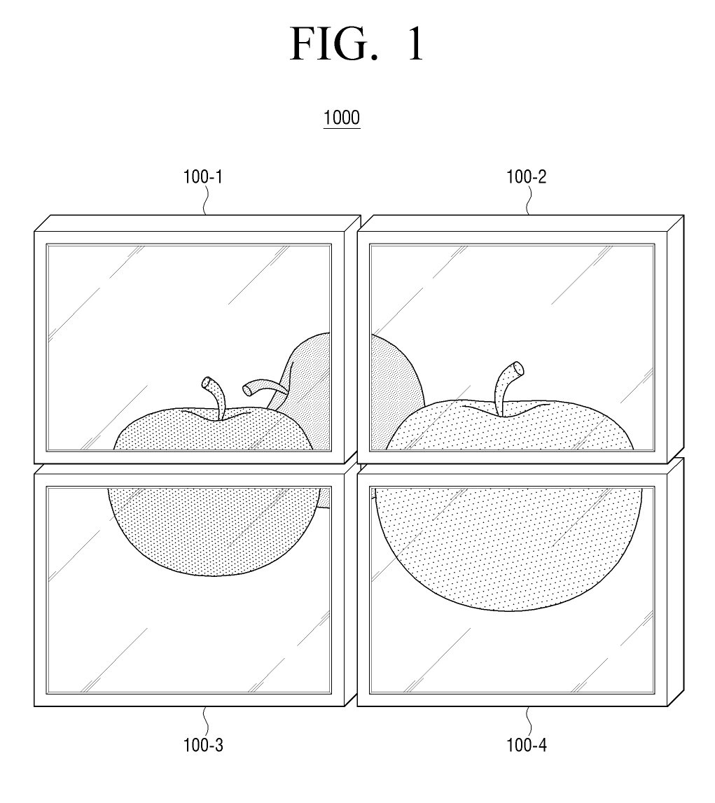

FIG. 1 is a diagram illustrating a display system 1000 including a plurality of display apparatuses according to an exemplary embodiment.

The display system 1000 includes a plurality of display apparatuses and is configured in such a way that the display apparatuses simultaneously display the same image or display different images as one whole image formed by combining the images.

FIG. 1 illustrates a situation in which four display apparatuses 100-1, 100-2, 100-3, and 100-4 simultaneously display an image of one apple. One of the four display apparatuses 100-1, 100-2, 100-3, and 100-4 can act as a source of each image displayed on the four display apparatuses 100-1, 100-2, 100-3, and 100-4.

For example, the first display apparatus 100-1 may transmit an apple image stored in the first display apparatus 100-1 to the second, third, and the fourth display apparatuses 100-2, 100-3, and 100-4 so as to display the apple image on the four display apparatuses 100-1, 100-2, 100-3, and 100-4. Likewise, the first display apparatus 100-1 that functions as an image source may be referred to as a host apparatus, and the second, third, and the fourth display apparatuses 100-2, 100-3, and 100-4 that receive the image from the first display apparatus 100-1 may be referred to as a slave apparatus.

In this case, when only one apparatus functions as a host apparatus, storage spaces of the remaining apparatuses are not capable of being used.

The display system 1000 according to an exemplary embodiment overcomes the aforementioned issue. That is, any of the four display apparatuses 100-1, 100-2, 100-3, and 100-4 is capable of functioning as a host apparatus, all storage spaces of the four display apparatuses 100-1, 100-2, 100-3, and 100-4 may be used. An internal memory of any display apparatus as well as an external memory (USB, SD card, and so on) connected to any display apparatus may be used.

Although the case in which four display apparatuses are used have been described, this is for convenience for description, and the number of display apparatuses constituting the display system 1000 is not limited thereto.

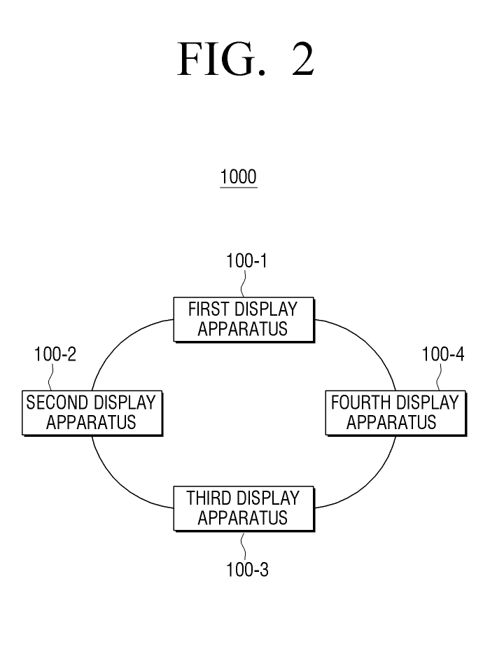

The display system 1000 according to an exemplary embodiment is conceptually illustrated in FIG. 2. Referring to FIG. 2, the first, second, third, and the fourth display apparatuses 100-1, 100-2, 100-3, and 100-4, respectively, may be connected to each other to transmit and receive various information items, commands, and contents.

Although FIG. 2 illustrates a state in which each display apparatus is connected directly to only an adjacent display apparatus, the connection scheme is not limited thereto, according to various exemplary embodiments. For example, each display apparatus may be connected directly to all the remaining display apparatuses.

According to the connection state illustrated in FIG. 2, for example, the first display apparatus 100-1 may be indirectly connected to the third display apparatus 100-3. That is, in order to transmit specific content to the third display apparatus 100-3, the first display apparatus 100-1 may indirectly transmit content to the third display apparatus 100-3 through the second display apparatus 100-2.

Hereinafter, indirect transmission and reception during transmission and reception of content will be described in the same way as in direct transmission. That is, even if content is indirectly transmitted to the third display apparatus 100-3 from the first display apparatus 100-1 through the second display apparatus 100-2, a description of the second display apparatus 100-2 may be omitted and the case in which the first display apparatus 100-1 transmits content to the third display apparatus 100-3 may be described instead.

Although FIG. 2 illustrates the case in which display apparatuses are connected through one wire, two or more communication paths may be embodied. In addition, communication may be performed in a wireless communication manner instead of a wired communication manner.

Each of the plurality of display apparatuses may transmit content stored therein to another display apparatus. For example, each of the plurality of display apparatuses may decode content stored therein and transmit the decoded content to another display apparatus through a display port.

In addition, each of the plurality of display apparatuses may search for content stored in an internal memory or external memory (USB, SD card, and so on) of another display apparatus. For example, content may be search for using UART communication. Accordingly, a display apparatus may provide a content list including content stored in the display apparatus and content stored in another display apparatus, which is retrieved as described above, to a user. The present exemplary embodiment will be described below in more detail.

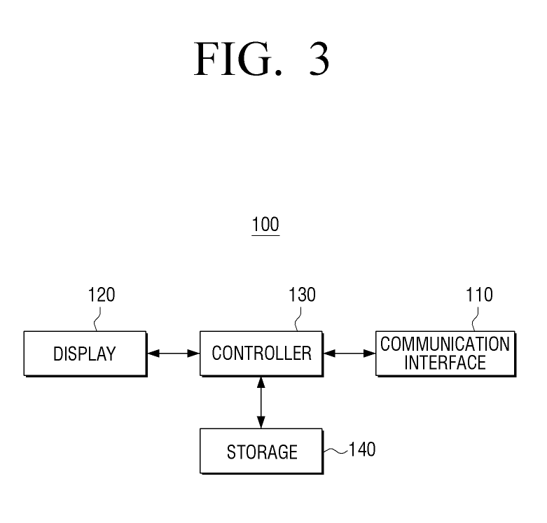

Hereinafter, a display apparatus 100 of a plurality of display apparatuses constituting the display system 1000 will be described with reference to FIG. 3, and the following description of the display apparatus 100 may be applied to any display apparatus constituting the display system 1000, for example display apparatuses 100-1, 100-2, 100-3, and 100-4 of FIG. 1.

Referring to FIG. 3, the display apparatus 100 according to an exemplary embodiment includes a communication interface 110, a display 120, a controller 130, and a storage 140.

The communication interface 110 may be a component for communication with an external device and may communicate with another display apparatus. In detail, content, information about content, information about a reproduction order of content, a reproduction command for content, and so on may be transmitted to another display apparatus through the communication interface 110 and may be received from another display apparatus. The communication interface 110 may use wired and wireless communication methods.

The storage 140 is a component for storing content. The storage 140 may store information about a reproduction order of content, information about storage for storing content to be reproduced, information about content reproduction options, and so on.

The display 120 may display various images according to control commands of the controller 130. In particular, the display 120 may display some images of content based on an arrangement position of the display apparatus 100 in the display system.

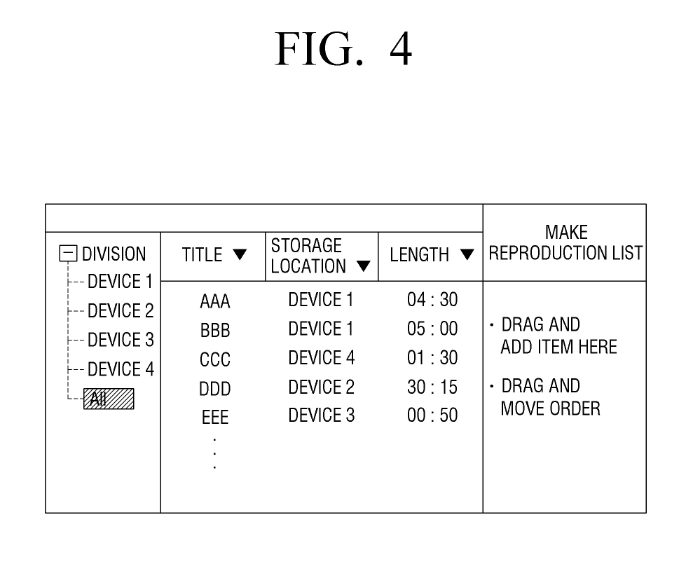

In addition, the display 120 may display a content list including content stored in the display apparatus 100 and content stored in another display apparatus. With reference to the display content list, a user may select content to be reproduced and determine an order of content to be reproduced. The present exemplary embodiment will be described below in more detail with reference to FIG. 4.

The controller 130 is a component for controlling the overall operation of the display apparatus 100. In particular, the controller 130 may control a display system including the display apparatus 100 and another display apparatus to display the content stored in the display apparatus 100. In addition, the controller 130 may receive the content stored in another display apparatus and display the content on the display 120.

For example, the controller 130 may transmit first content that is pre-stored in the display apparatus 100 to another display apparatus through the communication interface 110 so as to display the first content on another display apparatus in the display system. In addition, the controller 130 may receive second content stored in another display apparatus, which is different from the first content stored in the display apparatus 100, through the communication interface 110.

In addition, the controller 130 may display the first content stored in the display apparatus 100 and the second content received from another display apparatus on the display 120 based on an arrangement position of the display apparatus 100 on the display system.

In this case, the controller 130 may display the pre-stored first content or the received second content on the display 120 in an order based on pre-stored order information about a reproduction order of contents stored in respective display apparatuses constituting the display system.

Here, the order information may be referred to as a reproduction list and generated by the display apparatus 100 according to user inputs or manipulation. Alternatively, the order information may be generated by another display apparatus and received through the communication interface 110. According to another exemplary embodiment, the order information may be generated by a user terminal apparatus instead of a display apparatus constituting a display system and may be transmitted to the display apparatus 100.

An exemplary embodiment for generating the order information will be described with reference to FIG. 4.

FIG. 4 is a diagram illustrating a screen image used to receive user input used to generate a content reproduction order according to an exemplary embodiment.

In response to a user request to read contents stored in respective display apparatuses constituting a display system, the controller 130 may display the screen image of FIG. 4 including a list of the contents stored in the respective display apparatuses constituting the display system, on the display 120.

In detail, the controller 130 may receive information about content stored in another display apparatus from another display apparatus through the communication interface 110 and display a content list on the display 120 based on the received information and the information about the content stored in the display apparatus.

A user may check contents stored in all display apparatuses constituting the display system through the list displayed on the display 120 and check locations in which the contents are stored.

For example, as illustrated in FIG. 4, the controller 130 may display a list of the contents stored in all the display apparatuses including the display apparatus 100 on the display 120 and display a content list for each storage location on the display 120 according to user input.

In addition, in response to a user inputting a selection of content to be reproduced and an order of contents to be reproduced, the controller 130 may generate reproduction order information according to the user input. For example, as illustrated in FIG. 4, the controller 130 may receive selection of content to be reproduced through drag manipulation and may also display a screen image for determination of contents to be reproduced, together with the content list. Through this user interface, the controller 130 may receive user input and generate a reproduction order. However, this is merely exemplary and the user interface for receiving user input may be changed in various ways in addition to the user interface illustrated in FIG. 4.

The order information generated by the display apparatus 100 may be transmitted to another display apparatus.

In the aforementioned exemplary embodiment, the case in which the order information is generated by the display apparatus 100 has been described. However, according to another exemplary embodiment, the order information may be generated by an external terminal apparatus that is capable of communicating with the display apparatus 100 constituting the display system.

For example, information about content stored in each display apparatus constituting the display system may be transmitted to a user terminal apparatus such as a cellular phone, and the user terminal apparatus may display the screen image illustrated in FIG. 4. A user may input content to be reproduced through the terminal apparatus and manipulation of determination of a reproduction order of contents to be reproduced, and thus the terminal apparatus may generate information about the reproduction order of contents and transmit the information to each display apparatus constituting the display system.

Content stored in each display apparatus may be displayed on the display system based on the aforementioned generated order information. Hereinafter, for convenience of description, content stored in the display apparatus 100 will be referred to as first content and content stored in another display apparatus will be referred to as second content.

First, an exemplary embodiment in which the display apparatus 100 operates as a host apparatus will be described. Here, the expression ‘operating as a host apparatus’ means that the display apparatus 100 operates as a content source.

The controller 130 may transmit first content stored in the display apparatus 100 to another display apparatus at a time point for reproduction of the first content, based on pre-stored order information.

For example, when currently reproduced content is completed, if content to be reproduced next time according to the pre-stored order information is content stored in the display apparatus 100, the controller 130 may transmit the stored content to another display apparatus.

During reproduction of content, when user input including a request to skip current content and go to next content is input, if the next content is content stored in the display apparatus 100, the controller 130 may transmit the stored next content to another display apparatus.

During reproduction of content, when user manipulation of specific content is input, if the specific content is content stored in the display apparatus 100, the controller 130 may transmit the stored specific content to another display apparatus.

According to another exemplary embodiment, when another display apparatus stores the same order information as the order information stored in the display apparatus 100 and completes reproduction of second content stored in another display apparatus based on the order information, another display apparatus may transmit a reproduction command of the first content to the display apparatus 100. The controller 130 may transmit the first content to another display apparatus according to the first reproduction command of the first content.

The order information may include information about a place for storing content to be reproduced as well as an order of contents to be reproduced. When content to be reproduced next based on the order information is not stored in the display apparatus 100, the controller 130 may transmit a control command to another display apparatus such that another display apparatus that stores content to be reproduced next operates as a host apparatus.

For example, when reproduction of the first content is completed, the controller 130 transmits a reproduction command to another display apparatus that stores second content subsequent to the first content according to the order information. After the reproduction command is transmitted, the display apparatus 100 operates as a slave apparatus.

Here, the expression ‘operates as a slave apparatus’ means that another display apparatus operates as a content source and the display apparatus 100 operates as an apparatus that receives content from the other display apparatus and displays the content. As an extension of the aforementioned example, the controller 130 may receive second content from yet another display apparatus to which the second content is transmitted and display the received second content to the display 120.

According to an exemplary embodiment, different content displaying options may be applied to respective display apparatuses constituting a display system. In detail, when content to be reproduced is selected and user input setting a reproduction option for the selected content is received, the controller 130 may generate information about reproduction option settings according to the user input. The controller 130 may also transmit information about the generated reproduction option settings while transmitting content to another display apparatus. Accordingly, a display apparatus that receives information about the reproduction option setting may apply the corresponding reproduction option to the content and display the content.

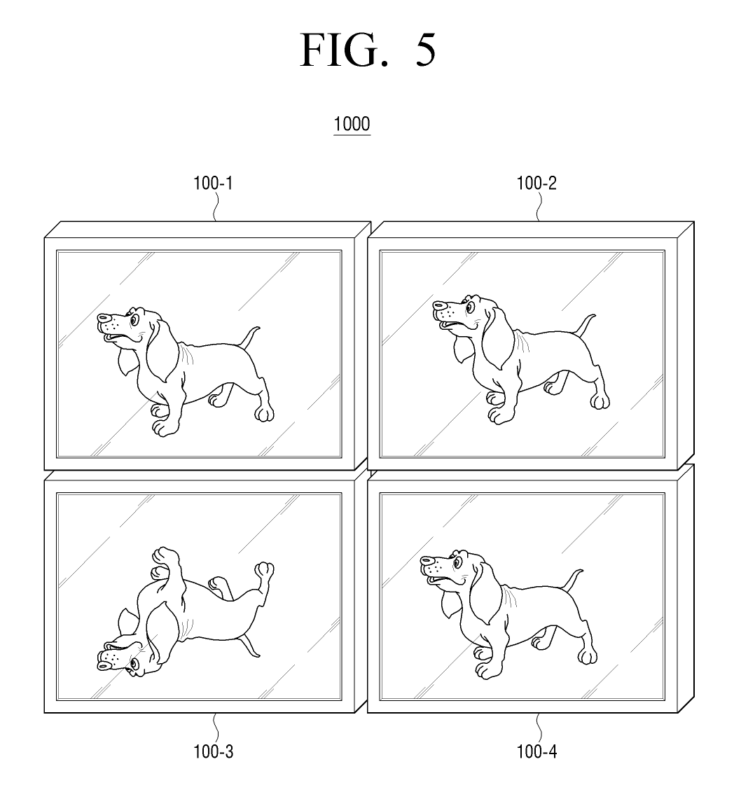

The present exemplary embodiment will be described in terms of a reproduction option with reference to FIG. 5. Referring to FIG. 5, the display system 1000 includes first, second, third, and fourth display apparatuses 100-1, 100-2, 100-3, and 100-4, respectively, and when the first display apparatus 100-1 operates as a host apparatus, the first display apparatus 100-1 transmits stored puppy image content to the second, third, and fourth display apparatuses 100-2, 100-3, and 100-4. In this case, the first display apparatus 100-1 stores information about content reproduction options that are differently set for the respective second, third, and fourth display apparatuses 100-2, 100-3, and 100-4, and also transmits the information about the content reproduction option while transmitting the puppy image. In the case of FIG. 5, the content reproduction option is a reproduction option that allows image content to be displayed on the second and fourth display apparatuses 100-2 and 100-4 in a specific orientation, and allows image content to be displayed on the third display apparatus 100-3 in a different orientation.

According to an exemplary embodiment, the aforementioned information about the content reproduction option may be included in the aforementioned order information. Accordingly, the order information may include an order of contents to be reproduced and a reproduction option of each of the contents to be produced. In addition, each display apparatus may pre-stored order information and may also transmit option information to be applied to the corresponding content while transmitting the stored content to another display apparatus. That is, the controller 130 may also transmit option information to be applied to the first content while transmitting the first content to another display apparatus.

According to another exemplary embodiment, the controller 130 may also transmit information about an arrangement position of another display apparatus on a display system while transmitting the first content to another display apparatus. Another display apparatus may receive information about an arrangement position and determine which portion of content to be displayed according to the information about the arrangement position.

The information about the arrangement position may be pre-stored. In this case, information about an arrangement position may not be necessarily received from another display apparatus. In addition, the controller 130 may perform image-processing so as to display a portion of the first content or the second content on the display 120 based on the arrangement position of the display apparatus 100 on the display system.

According to the aforementioned various exemplary embodiments, the cases in which each display apparatus constituting a display system operates as a host apparatus and a slave apparatus have been described. That is, since any display apparatus can operate as a host apparatus, when a control signal is input to the display apparatus from a remote control apparatus such as a remote controller, only a display apparatus that operates as a host apparatus requires an element that responds to a control signal.

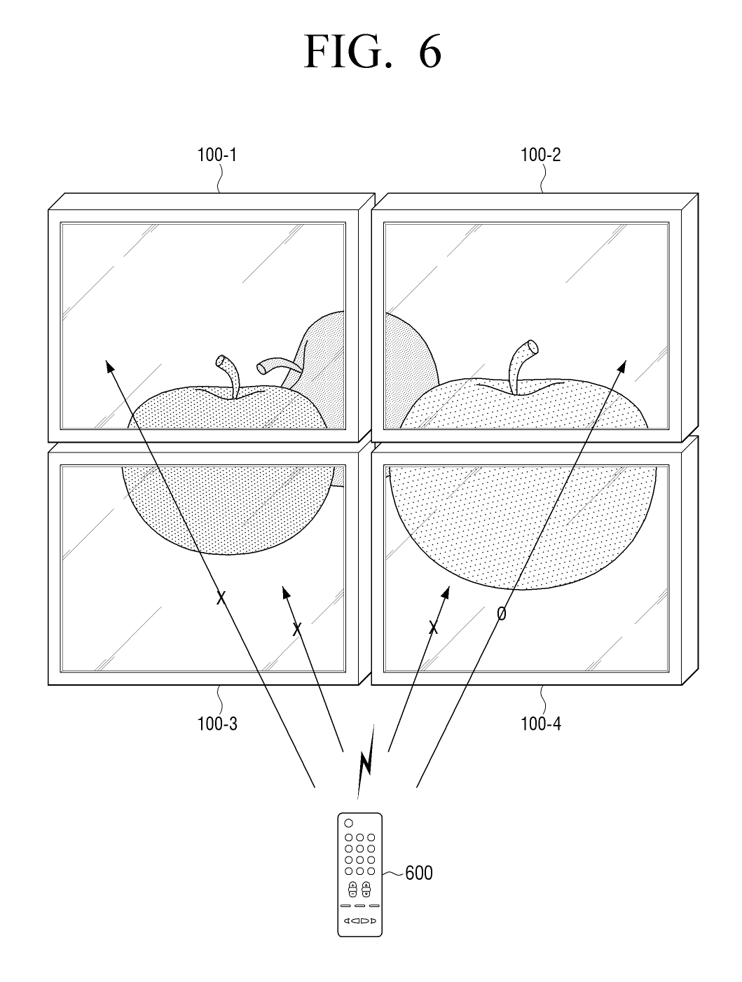

To this end, according to an exemplary embodiment, when the display apparatus 100 is a slave apparatus that is controlled by another display apparatus, the controller 130 may disregard a control command received from the remote control apparatus. The present exemplary embodiment will be described with reference to FIG. 6.

Referring to FIG. 6, when the second display apparatus 100-2 operates as a host apparatus and receives a control command from a remote control apparatus 600, the first, third, and fourth display apparatuses 100-1, 100-3, and 100-4 which operate as lave apparatuses may disregard the control command. For example, when the control command is a command for reproduction of next content, only the second display apparatus 100-2 as a host apparatus stops transmitting current content according to the control command. In addition, the second display apparatus 100-2 may transmit a command to reproduce the next content to another display apparatus that stores the next content, based on a reproduction order. When the next content is stored in the second display apparatus 100-2, the second display apparatus 100-2 transmits the next content to the first, third, and fourth display apparatuses 100-1, 100-3, and 100-4.

As another example, when the control command is a command for controlling a form for displaying currently reproduced content, for example, when the control command is a command for displaying content in a different orientation, if all the first, third, and fourth display apparatuses 100-1, 100-3, and 100-4 were to respond the command, each display apparatus display would an image in the different orientation, and thus one apple image is not wholly displayed. Accordingly, according to the present exemplary embodiment, the second display apparatus 100-2 that responds to a control command may transmit appropriate separate images to the respective first, third, and fourth display apparatuses 100-1, 100-3, and 100-4 so as to wholly display an apple image in a different orientation.

As another example, in response to a control command corresponding to input of a reproduction order being received from the remote control apparatus 600, the first, third, and fourth display apparatuses 100-1, 100-3, and 100-4 may disregard the control command, and the second display apparatus 100-2 may generate a reproduction order according to the control command. Thus, a generating procedure of the reproduction order may prevent unnecessary processes performed by the first, third, and fourth display apparatuses 100-1, 100-3, and 100-4.

According to the aforementioned various exemplary embodiments, each of a plurality of display apparatuses constituting a display system may sequentially operate as a host apparatus, and accordingly can use all memories of the plurality of display apparatuses. In this case, the memories may correspond to an external memory such as a universal serial bus (USB) as well as an internal memory of the display apparatus.

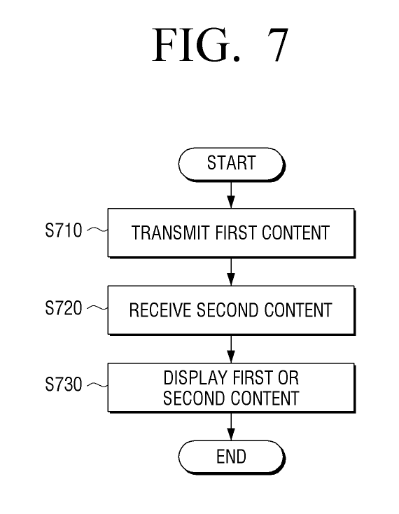

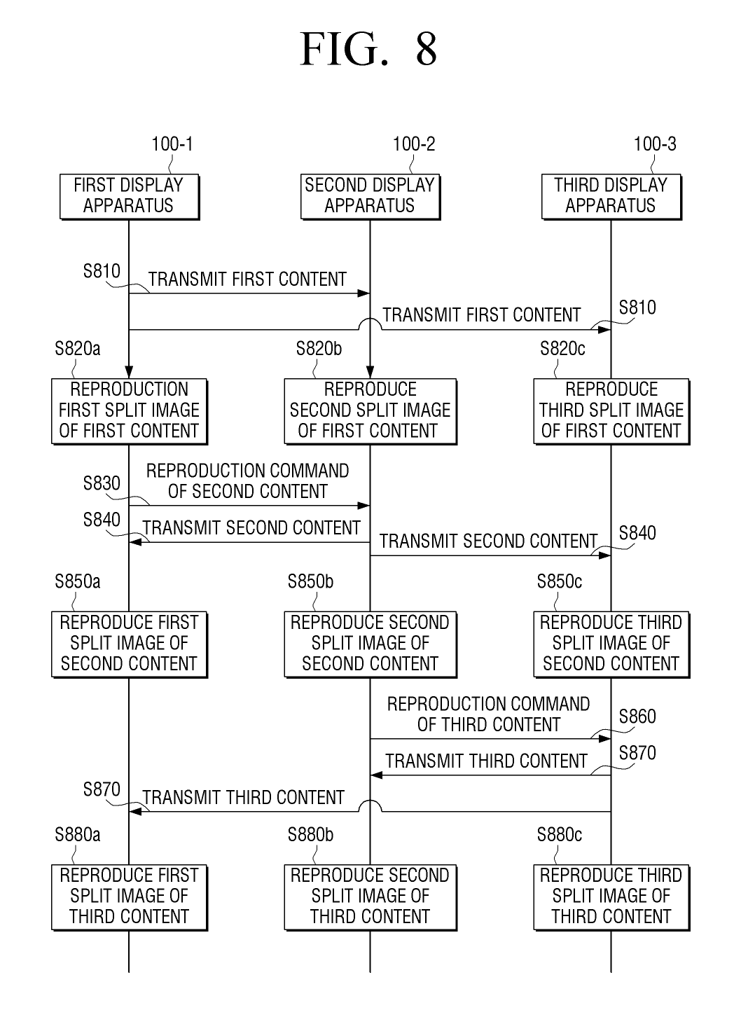

Hereinafter, a method of displaying content of a display apparatus constituting a display system according to various exemplary embodiments will be described with reference to FIGS. 7 and 8.

FIG. 7 is a flowchart for explanation of a method of displaying content of a display apparatus constituting a display system according to an exemplary embodiment.

Referring to FIG. 7, the display apparatus 100 transmits first content that is pre-stored in the display apparatus 100 to another display apparatus constituting the display system so as to display the first content on another display apparatus (S710).

That is, the display apparatus 100 operates as a host apparatus. In this case, upon determining that a pre-stored reproduction order as a reproduction order of the first content, the display apparatus 100 may transmit the first content to another display apparatus. Alternatively, upon receiving a reproduction command of the first content from another display apparatus, the display apparatus 100 may transmit the first content to another display apparatus. Various exemplary embodiments of the case in which the display apparatus 100 operates as a host apparatus have been described already, and thus a detailed description thereof will not be repeated here.

In addition, the display apparatus 100 receives second content that is pre-stored in another display apparatus, which is different from the first content (S720). That is, the display apparatus 100 operates as a slave apparatus. In this case, any one of other display apparatuses constituting a display system operates as a host apparatus. Various exemplary embodiments of the case in which the display apparatus 100 operates as a slave apparatus have been described already, and thus a detailed description thereof will not be repeated here.

In addition, the display apparatus 100 displays pre-stored first content or received second content based on the arrangement position of the display apparatus 100 on the display system (S730). For example, when the display system includes four display apparatuses as illustrated in FIG. 1, if the position of the display apparatus 100 is the same as a position of the first display apparatus of FIG. 1, the display apparatus 100 may display a first image among images obtained by dividing the first content or the second content into four pieces.

FIG. 8 is a sequence diagram for explanation of a method of displaying content of a display apparatus constituting a display system according to an exemplary embodiment.

Referring to FIG. 8, the display system includes first, second, and third display apparatuses 100-1, 100-2, and 100-3.

Upon determining that first content as first reproduced content is stored in the first display apparatus 100-1 based on pre-stored order information, a controller of the first display apparatus 100-1 transmits the first content to the second and the third display apparatuses 100-2 and 100-3 (S810).

When the first content as first reproduced content is stored in another display apparatus that is not the first display apparatus 100-1, a reproduction command for the first content is transmitted to another display that stores the first content as first reproduced content.

In addition, the first, second, and third display apparatuses 100-1, 100-2, and 100-3 reproduce the first content. In detail, according to an arrangement order of the first, second, and third display apparatuses 100-1, 100-2, and 100-3, the first display apparatus 100-1 reproduces a first split image of the first content (S820a), the second display apparatus 100-2 reproduces a second split image of the first content (S820b), and the third display apparatus 100-3 reproduces a third split image of the first content (S820c). Accordingly, in terms of an overall display system including the first, second, and third display apparatuses 100-1, 100-2, and 100-3, the first content is viewed as if it were reproduced on one large display apparatus.

In addition, upon determining that second content subsequent to the first content is stored in the second display apparatus 100-2 based on a pre-stored reproduction order, the first display apparatus 100-1 delivers authority of a host apparatus to the second display apparatus 100-2. That is, the first display apparatus 100-1 transmits a reproduction command of the second content to the second display apparatus 100-2 (S830). Accordingly, the second display apparatus 100-2 is a host apparatus.

The second display apparatus 100-2 transmits the stored second content to the first and third display apparatuses 100-1 and 100-3 (S840). In addition, the first, second, and third display apparatuses 100-1, 100-2, and 100-3 reproduce the second content. In detail, according to an arrangement order of the first, second, and third display apparatuses 100-1, 100-2, and 100-3, the first display apparatus 100-1 reproduces a first split image of the second content (S850a), the second display apparatus 100-2 reproduces a second split image of the second content (S850b), and the third display apparatus 100-3 reproduces a third split image of the second content (S850c). Accordingly, in terms of an overall display system including the first, second, and third display apparatuses 100-1, 100-2, and 100-3, the second content is viewed as if it were reproduced on one large display apparatus.

In addition, upon determining that third content subsequent to the second content is stored in the third display apparatus 100-3 based on a pre-stored reproduction order, the second display apparatus 100-2 delivers authority of a host apparatus to the third display apparatus 100-3. That is, the second display apparatus 100-2 transmits a reproduction command of the third content to the third display apparatus 100-3 (S860). Accordingly, the third display apparatus 100-3 is a host apparatus.

The third display apparatus 100-3 transmits the stored third content to the first and second display apparatuses 100-1 and 100-2 (S870). In addition, the first, second, and third display apparatuses 100-1, 100-2, and 100-3 reproduce the third content. In detail, according to an arrangement order of the first, second, and third display apparatuses 100-1, 100-2, and 100-3, the first display apparatus 100-1 reproduces a first split image of the third content (S880a), the second display apparatus 100-2 reproduces a second split image of the third content (S880b), and the third display apparatus 100-3 reproduces a third split image of the third content (S880c). Accordingly, in terms of an overall display system including the first, second, and third display apparatuses 100-1, 100-2, and 100-3, the third content is viewed as if it were reproduced on one large display apparatus.

When there are other content to be reproduced according to a reproduction order, the aforementioned processes may be repeated, and the first, second, and third display apparatuses 100-1, 100-2, and 100-3 may be sequentially in charge of a host apparatus.

In addition, various content reproducing methods may be extracted based on the description that has been given with reference to FIGS. 1 to 6. The various content reproducing methods have been described and thus will not be described again.

According to the aforementioned various exemplary embodiments, a method of displaying content of a display apparatus constituting a display system including a plurality of display apparatuses may be stored in a non-transitory readable medium. The non-transitory readable medium may be installed and used in various apparatuses.

The non-transitory computer readable media refers to a medium that semipermanently stores data and is readable by a device instead of a medium that stores data for a short time period, such as a register, a cache, a memory, etc. In detail, the aforementioned programs may be stored and provided in the non-transitory computer readable media such as CD, DVD, hard disc, blue ray disc, USB, a memory card, ROM, etc.

Accordingly, the aforementioned program may be installed in a legacy display apparatus, and thus a display system including display apparatuses that simultaneously operate as a host apparatus and a slave apparatus may be embodied.

The foregoing exemplary embodiments and advantages are merely exemplary and are not to be construed as limiting the present invention. Also, the description of the exemplary embodiments is intended to be illustrative, and not to limit the scope of the claims, and many alternatives, modifications, and variations will be apparent to those skilled in the art.

What is claimed is:

1. A content display method of a first display apparatus in a display system which includes a plurality of display apparatuses, the content display method comprising:
transmitting first content pre-stored in the first display apparatus to a second display apparatus of the plurality of display apparatuses in order to display the first content on the second display apparatus;
receiving second content stored in the second display apparatus, wherein the second content is different from the first content; and
displaying the pre-stored first content or the received second content based on an arrangement position of the first display apparatus in relation to the plurality of display apparatuses.

2. The content display method as claimed in claim 1, wherein the displaying comprises displaying the pre-stored first content or the received second content based on pre-stored order information about a reproduction order of contents stored in the plurality of display apparatuses.

3. The content display method as claimed in claim 2, wherein the transmitting comprises transmitting the first content to the second display apparatus at a time for reproduction of the pre-stored first content, wherein the time for reproduction is based on the order information.

4. The content display method as claimed in claim 2, further comprising, in response to reproduction of the first content being terminated, transmitting a reproduction command for second content stored in the second display apparatus to the second display apparatus.

5. The content display method as claimed in claim 2, further comprising, in response to reproduction of the second content being terminated, receiving a reproduction command of the first content from the second display apparatus,
wherein the transmitting comprises transmitting the first content to the second display apparatus according to the received reproduction command of the first content.

6. A first display apparatus in a display system which includes a plurality of display apparatuses, the first display apparatus comprising:
a communication interface configured to communicate with a second display apparatus of the plurality of display apparatuses;
a storage configured to store content;
a display configured to display content; and
a controller configured to transmit first content pre-stored in the storage to the second display apparatus through the communication interface in order to display the first content on the second display apparatus, to receive second content stored in the second display apparatus, the second content being different form the first content, through the communication interface, and to display the pre-stored first content or the received second content on the display based on an arrangement position of the first display apparatus in relation to the plurality of display apparatuses.

7. The first display apparatus as claimed in claim 6, wherein the controller displays the pre-stored first content or the received second content based on pre-stored order information about a reproduction order of contents stored in the plurality of display apparatuses.

8. The first display apparatus as claimed in claim 7, wherein the controller transmits the first content to another display apparatus of the plurality of display apparatuses at a time for reproduction of the pre-stored first content, wherein the time for reproduction is based on the order information.

9. The first display apparatus as claimed in claim 7, wherein the controller, in response to reproduction of the first content being terminated, transmits a reproduction command of second content stored in the second display apparatus to another display apparatus of the plurality of display apparatuses.

10. The first display apparatus as claimed in claim 9, the reproduction command is transmitted to the second display apparatus that stores second content corresponding to the order information.

11. The first display apparatus as claimed in claim 9, wherein the controller receives the second content from another display apparatus of the plurality of display apparatuses to which the reproduction command is transmitted.

12. The first display apparatus as claimed in claim 7, wherein the controller, in response to reproduction of the second content being terminated, receives a reproduction command of the first content from the second display apparatus, and transmits the first content to the second display apparatus according to the received reproduction command of the first content.

13. The first display apparatus as claimed in claim 6, wherein the controller displays a list of contents stored in the plurality of display apparatuses in the display system on the display, generates order information based on a reproduction order of the displayed contents received from a user, and transmits the generated order information to the second display apparatus.

14. The first display apparatus as claimed in claim 13, wherein:
a control command corresponding to the reproduction order is received from a remote control apparatus that performs communication using wireless communication; and
the controller disregards a control command received from the remote control apparatus when the first display apparatus is a slave apparatus controlled by another display apparatus of the plurality of display apparatuses.

15. The first display apparatus as claimed in claim 13, wherein the controller receives information about content stored in the second display apparatus from the second display apparatus and displays the received information in the list of contents on the display.

16. The first display apparatus as claimed in claim 13, wherein the controller transmits a reproduction command regarding a content to be reproduced first to another display apparatus of the plurality of display apparatuses that stores the content to be reproduced first, based on the generated order information.

17. The first display apparatus as claimed in claim 6, wherein the controller controls a displayed form of an image display on the display according to a control command received from a remote control apparatus when the first display apparatus is a host apparatus, and disregards the control command received from the remote control apparatus when the first display apparatus is a slave apparatus controlled by another display apparatus of the plurality of display apparatuses.

18. The first display apparatus as claimed in claim 6, wherein the controller performs image-processing in order to display a portion of the first content or the second content on the display based on an arrangement position of the first display apparatus in relation to the plurality of display apparatuses.

19. The first display apparatus as claimed in claim 6, wherein the controller also transmits information about an arrangement position of the second display apparatus in relation to the plurality of display apparatuses while transmitting the first content to the second display apparatus.

20. A display system comprising a plurality of display apparatuses, the display system comprising:
a first display apparatus configured to store first content and to display the first content on the plurality of display apparatuses; and
a second display apparatus configured to store second content different from the first content, and to display the second content on the plurality of display apparatuses in response to reproduction of the first content being terminated.
